(19) United States
(12) Patent Application Publication
(10) Pub. No.: US 2015/0171558 A1
(43) Pub. Date: Jun. 18, 2015

(54) ELECTRICAL CONNECTOR ASSEMBLY WITH IMPROVED METALLIC SHELL

(71) Applicant: ALLTOP ELECTRONICS (SUZHOU) LTD, Taicang City (CN)

(72) Inventors: Wang-I YU, Jhonghe City (TW); Hung-Chi TAI, Jhonghe City (TW); Yung-Chih HUNG, Jhonghe City (TW)

(73) Assignee: ALLTOP ELECTRONICS (SUZHOU) LTD, Taicang City (CN)

(21) Appl. No.: 14/196,516

(22) Filed: Mar. 4, 2014

(30) Foreign Application Priority Data
Dec. 12, 2013 (CN) 201310671181.6

(51) Int. Cl. H01R 13/648; H01R 13/516

(52) U.S. Cl. CPC H01R 13/648; H01R 13/516

(57) ABSTRACT

An electrical connector assembly includes a number of stacked connectors and a metallic shell enclosing the stacked connectors. The stacked connectors include an insulative housing and a number of contact groups received in the insulative housing. The insulative housing includes a mating portion and a receiving portion extending rearwardly from the mating portion. The contact groups include a first contact group, a second contact group, a third contact group and a fourth contact group separable with one another. Each of the contact groups includes a number of contacts, and the contacts of the first, second, third and fourth contact groups are arranged in turn along a top-to-bottom direction and a rear-to-front direction.

### BACKGROUND OF THE INVENTION

1. Field of the Invention

The present invention relates to an electrical connector assembly for being mounted to a circuit board, and more particularly to an electrical connector assembly with an improved metallic shell.

2. Description of Related Art

With rapid development of electronic technologies, electrical connectors have been widely used in electronic devices for exchanging information and data with external devices. A conventional connector usually includes an insulative housing, a plurality of contacts received in the insulative housing and a metallic shell enclosing the insulative housing. Each contact includes a soldering portion extending beyond the insulative housing for being soldered to a circuit board.

In order to meet the requirements of stable signal transmission and high effective transmission of the electronic devices, strong mating stabilization of the electrical connector needs to be ensured. However, the assembly of the conventional SFP connector is not convenient. Besides, since all the contacts are embedded in a single spacer, when one of the contacts is broken, all the contacts together with the spacer should be entirely replaced. Apparently, it wastes of cost.

Hence, an electrical connector assembly with improved contact groups is desired.

### BRIEF SUMMARY OF THE INVENTION

The present invention provides an electrical connector assembly including a plurality of stacked connectors and a metallic shell enclosing the stacked connectors. The stacked connectors include an insulative housing and a plurality of contact groups received in the insulative housing. The insulative housing includes a mating portion and a receiving portion extending rearwardly from the mating portion. The contact groups include a first contact group, a second contact group, a third contact group and a fourth contact group separable with one another. Each of the contact groups includes a plurality of contacts, and the contacts of the first, second, third and fourth contact groups are arranged in turn along a top-to-bottom direction and a rear-to-front direction.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of an electrical connector assembly in accordance with an illustrated embodiment of the present invention;

FIG. 2 is a partly exploded view of the electrical connector assembly as shown in FIG. 1;

FIG. 3 is a perspective view of a stacked connector as shown in FIG. 2;

FIG. 4 is an exploded view of the stacked connector as shown in FIG. 3;

FIG. 5 is a perspective view of an insulative housing as shown in FIG. 4;

FIG. 6 is another perspective view of the insulative housing as shown in FIG. 5;

FIG. 7 is an exploded view of a first contact group as shown in FIG. 4;

FIG. 8 is a perspective view of a first cage as shown in FIG. 2;

FIG. 9 is a perspective view of a second cage as shown in FIG. 2;

FIG. 10 is a perspective view of a third cage as shown in FIG. 2; and

FIG. 11 is a perspective view of a separating plate as shown in FIG. 2.

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

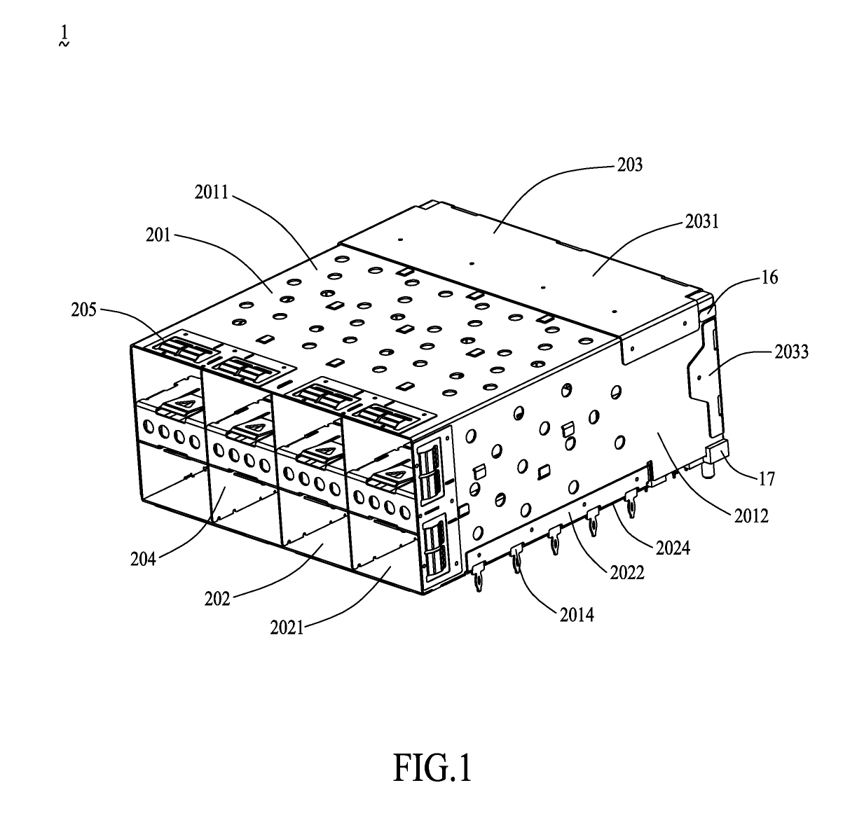

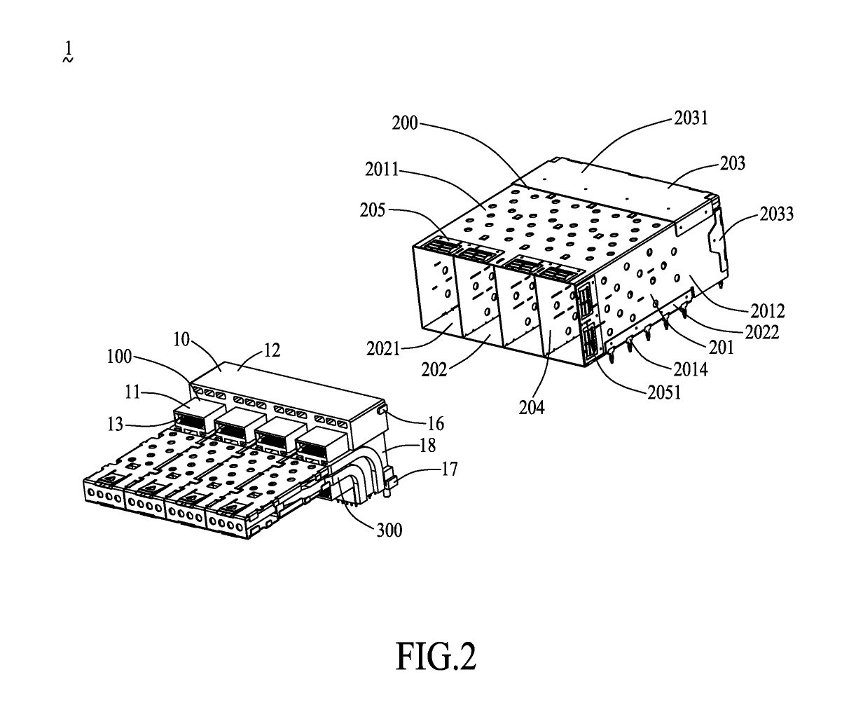

Referring to FIGS. 1 and 2, the present invention discloses an electrical connector assembly 1 for being mounted on a circuit board (not shown) for receiving a mating plug (not shown). The electrical connector assembly 1 includes a plurality of stacked connectors 100, a metallic shell 200 enclosing the stacked connectors 100 and a plurality of light pipes 300 between the stacked connectors 100 and the metallic shell 200.

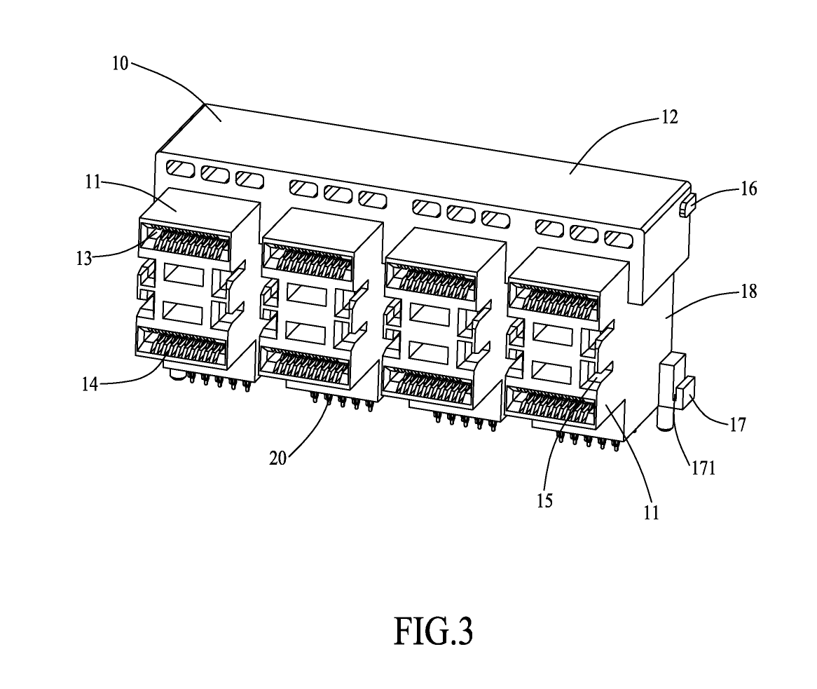

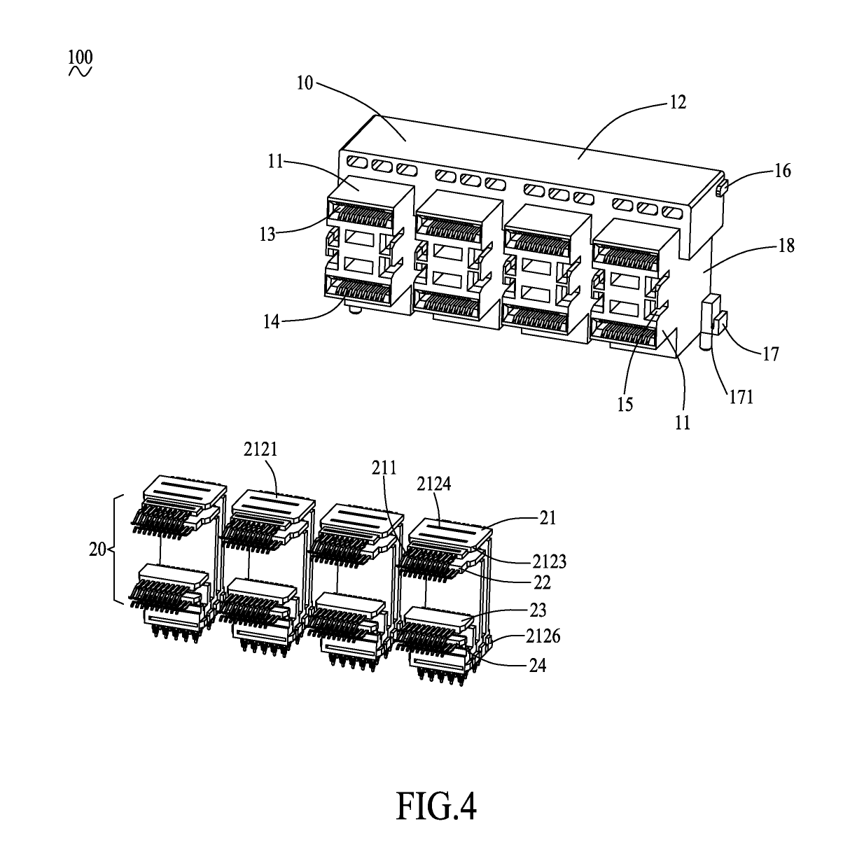

Referring to FIGS. 3 and 4, each stacked connector 100 includes an insulative housing 10 and a plurality contact groups 20 retained in the insulative housing 10. The contact groups 20 include a first contact group 21, a second contact group 22, a third contact group 23 and a fourth contact group 24 in turn along a top-to-bottom direction and a rear-to-front direction. The first, second, third and fourth contact groups 21, 22, 23 and 24 are of similar configurations, and the differences among them are that length and height of the first, second, third and fourth contact groups 21, 22, 23 and 24 are decreased in turn. The first, second, third and fourth contact groups 21, 22, 23 and 24 are separable with one another for easily replacement.

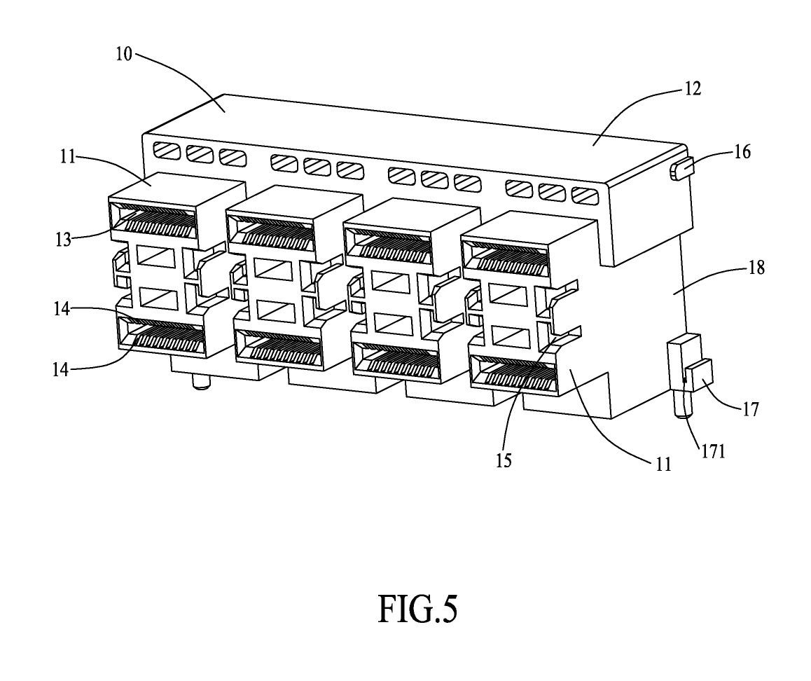

Referring to FIGS. 1 to 6, the insulative housing 10 includes a plurality of mating portions 11 and a plurality of receiving portions 12 extending rearwardly from the mating portions 11. Each mating portion 11 defines a mating slot 13 for receiving the mating plug and a plurality of passageways 14 extending rearwardly through the receiving portion 12 for mounting the contact groups 20. In accordance with the illustrated embodiment of the present invention, the passageways 14 include a plurality of upper passageways and lower passageways.

According to the illustrated embodiment of the present invention, the mating portions 11 along a height direction (a vertical direction) of the insulative housing 10 present two stories and four lines. Referring to FIG. 3, the stacked connectors 100 can be regarded as connected side by side. Each stacked connector 100 includes a pair of slot 15 for assembling and fixing the light pipes 300. The first contact group 21 and the second contact group 22 are received in one of the mating portions 11 (i.e., an upper mating portion 11), and the third contact group 23 and the fourth contact group 24 are received in the other of the mating portions 11 (i.e., a lower mating portion 11). The first, second, third and fourth contact groups 21, 22, 23 and 24 extend beyond a bottom wall of the insulative housing 10 from the receiving portions 12. The upper passageways adapted for receiving the first contact group 21 are located between the lower passageways adapted for receiving the second contact group 22 along the vertical direction. Similarly, the upper passageways adapted for receiving the third contact group 23 are located between the lower passageways adapted for receiving the fourth contact group 24 along the vertical direction.

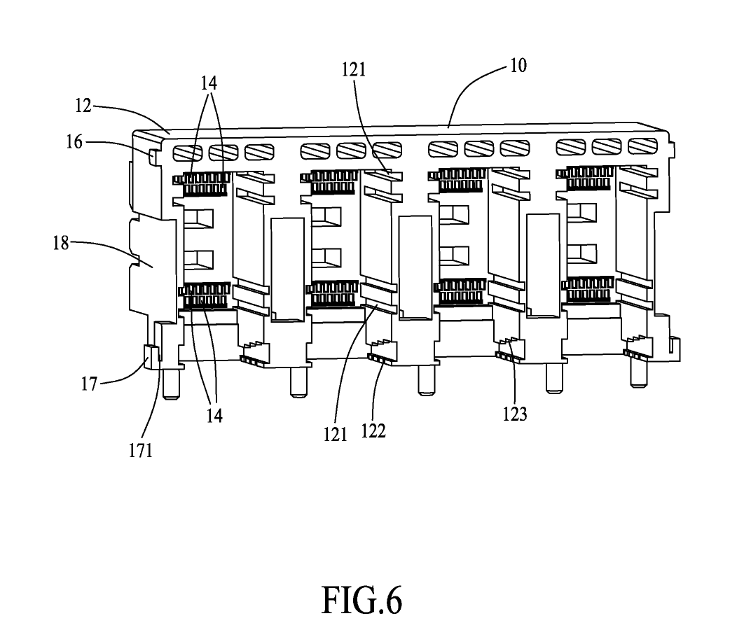

Referring to FIG. 6, each receiving portion 12 defines a plurality of guiding slots 121, a plurality of locking slots 122 at a bottom side thereof and a plurality of restricting slots 123 above the locking slots 122. The guiding slots 121, the restricting slots 123 and the locking slots 122 are arranged in turn along the vertical direction. Besides, the insulative housing 10 further includes a pair of first blocks 16 and a pair of second blocks 17 protruding outwardly from opposite sides of the receiving portion 12. The first blocks 16 are located at a top side of the receiving portion 12, while the second blocks 17 are located at a bottom side of the receiving portion 12. Each second block 17 defines a positioning slit 171. Furthermore, the insulative housing 10 includes a pair of fixing slots 18 on the opposite sides of the receiving portion 12 and located between the first blocks 16 and the second blocks 17.

Referring to FIGS. 2 to 7, the contact groups 20 are inserted into the mating portions 11 from the receiving portions 12 along the rear-to-front direction. Since the first, second, third and fourth contact groups 21, 22, 23 and 24 are of the similar configurations, only the first contact group 21 is selected for elaboration.

The first contact group 21 includes a plurality of first contacts 211 and at least one spacer 212 over-molding the first contacts 211. Each first contact 211 includes a contacting section 2111, an extending section 2112 extending rearwardly from the contacting section 2111, a bent section 2113 bent downwardly from the extending section 2112 and a press-fit leg 2114 extending from the bent section 2113. Each first contact 211 is of an L-shaped configuration taken from an integral view.

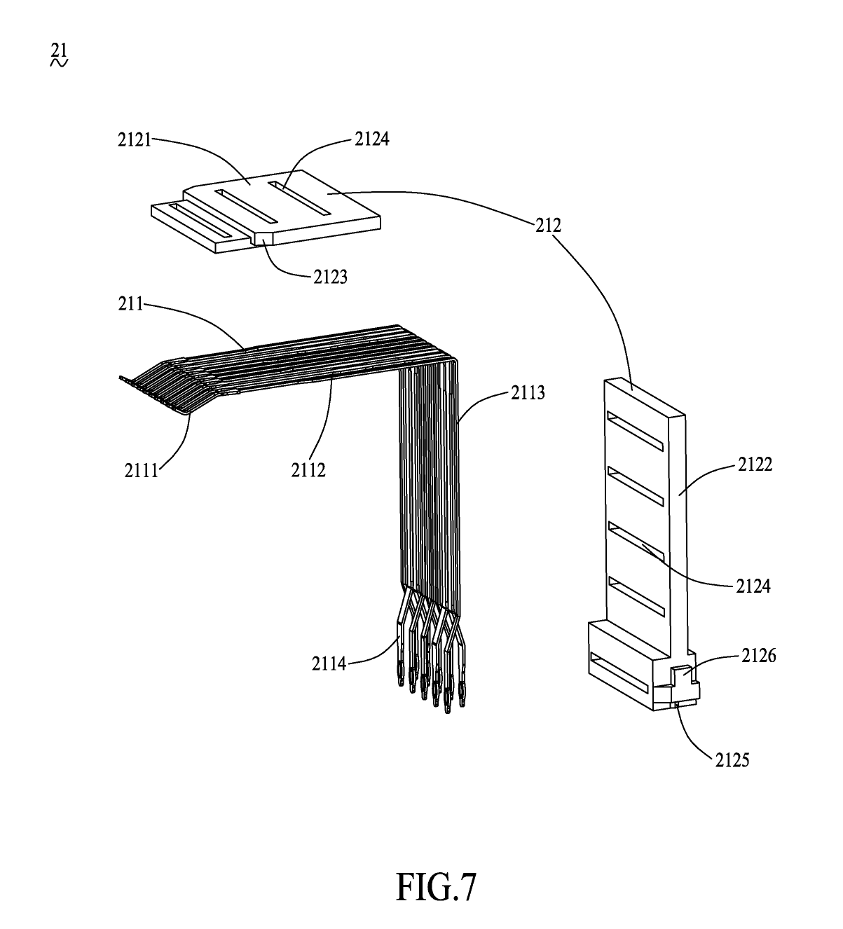

The contacting sections 2111 are curved and elastic. When the contacting sections 2111 are received in the passageways 14, they partly extend into the mating slot 13 for easily mating with the mating plug. The press-fit legs 2114 are of V-shaped or Z-shaped configurations. As shown in FIG. 7, the press-fit legs 2114 of adjacent contacts of the same contact group are bent along opposite directions so that the press-fit legs 2114 can be regulated in two rows. Such two-row arrangement of the press-fit legs 2114 is easily for being mounted to the circuit board, especially when the press-fit legs 2114 are of high density. Referring to FIGS. 4 and 7, the contacting sections 2111 of the first, second, third and fourth contact groups 21, 22, 23 and 24 are arranged in turn along a top-to-bottom direction in four stories, and the press-fit legs 2114 of the first, second, third and fourth contact groups 21, 22, 23 and 24 are arranged in turn a rear-to-front direction in eight rows.

The contacting sections 2111 of the first contact group 21 and the second contact group 22 are bent along opposite directions and are arranged in a face-to-face manner. The contacting sections 2111 of the first contact group 21 are located between the contacting sections 2111 of the second contact group 22 along the vertical direction. Similarly, the contacting sections 2111 of the third contact group 23 and the fourth contact group 24 are bent along opposite directions and are arranged in a face-to-face manner as well. The contacting sections 2111 of the third contact group 23 are located between the contacting sections 2111 of the fourth contact group 24 along the vertical direction.

The spacer 212 includes a first spacer 2121 over-molding the extending sections 2112 and a second spacer 2122 over-molding the bent sections 2113 and/or the press-fit legs 2114. The first spacer 2121 includes a pair of opposite inclined surfaces 2123 for easily guiding insertion of the first spacer 2121 into the insulative housing 10. According to the illustrated embodiment of the present invention, both the first spacer 2121 and the second spacer 2122 define a plurality of heat-dissipating slots 2124 so that heat generated by each contact group can be dissipated to the air through such heat-dissipating slots 2124.

When the first contact group 21 is assembled to the insulative housing 10, under the guidance of the inclined surfaces 2123, lateral sides of the first spacer 2121 is received in the guiding slot 121. Besides, the second spacer 2122 is perpendicular to the first spacer 2121. The second spacer 2122 includes a pair of locking blocks 2125 secured in the locking slots 122 and a pair of restricting blocks 2126 connected above corresponding locking blocks 2125 for being received in the restricting slots 123. As a result, the first contact group 21 can be prevented from withdrawing from the insulative housing 10.

Referring to FIG. 2, the metallic shell 200 includes an essentially reverse U-shaped first cage 201, a second cage 202 for mating with the first cage 201 from a bottom side, and a third cage 203 for mating with the first cage 201 from a rear side.

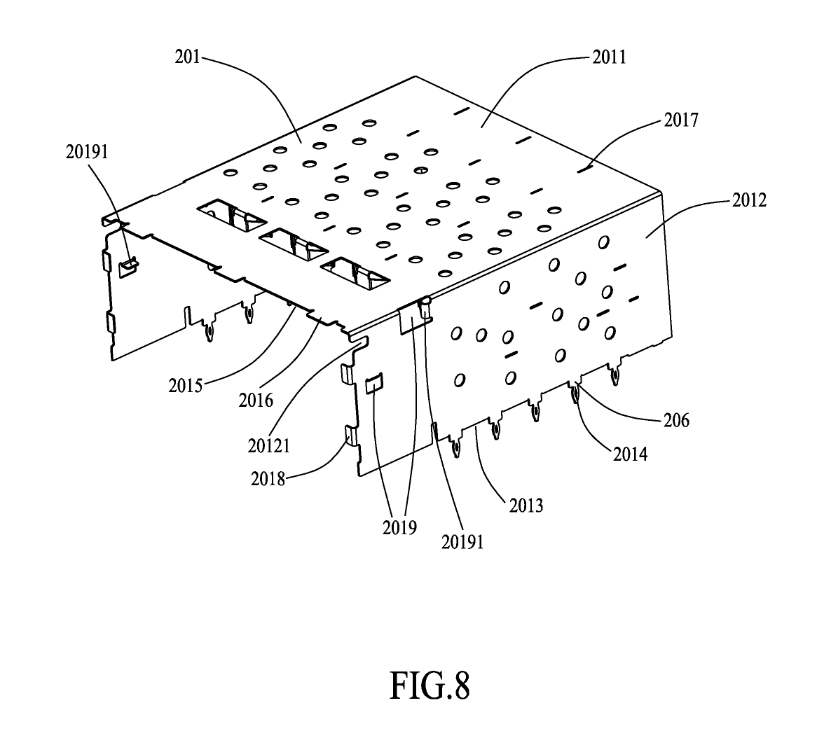

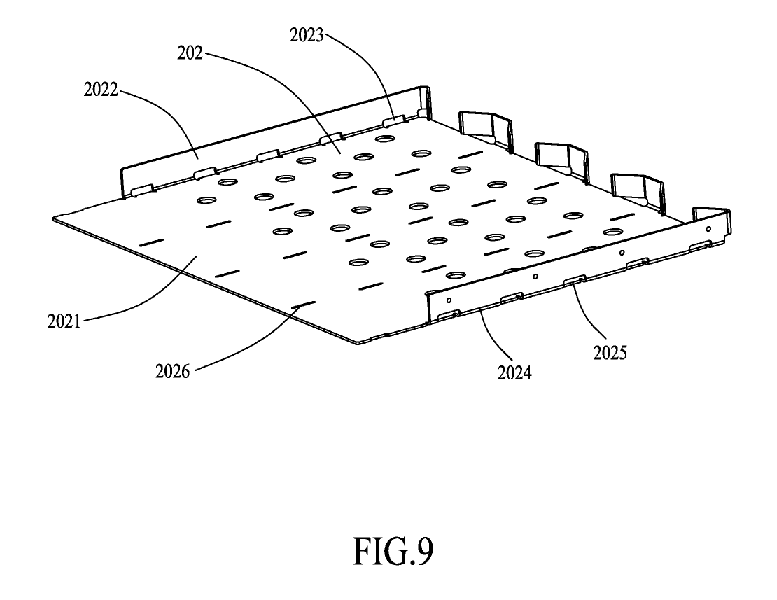

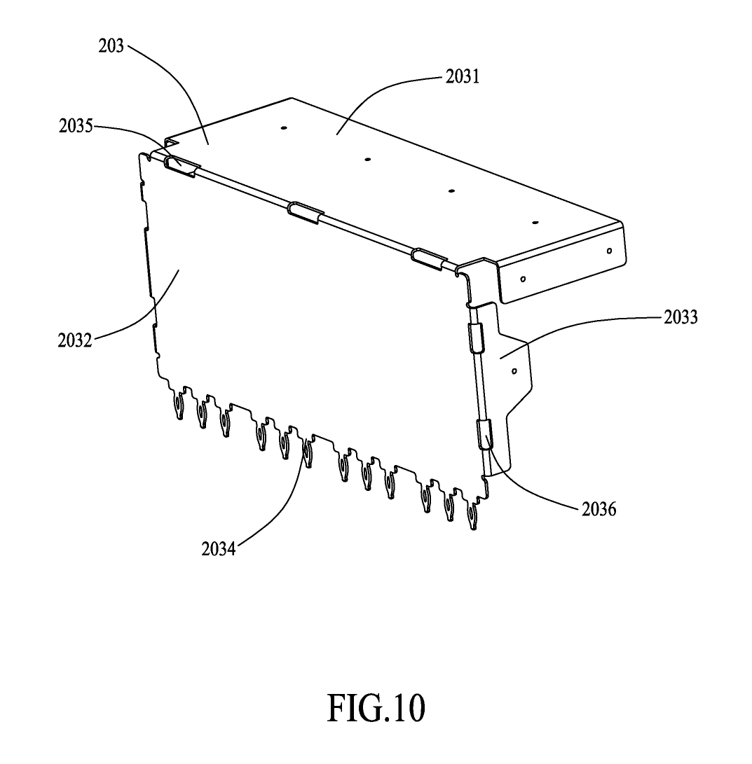

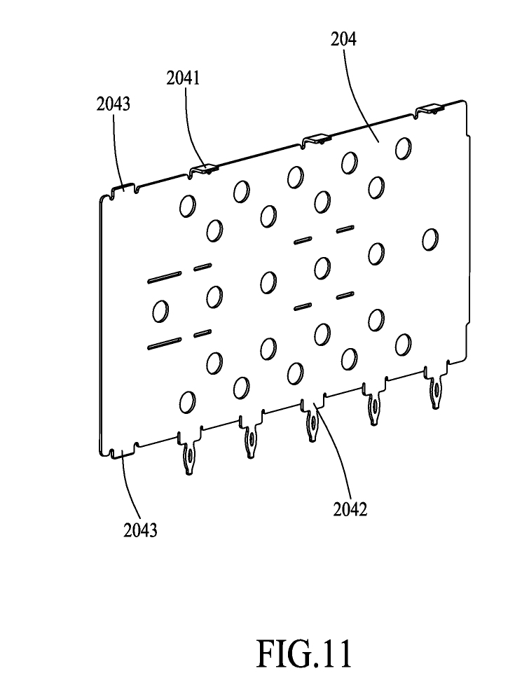

Referring to FIGS. 8 to 11, the first cage 201 includes a base portion 2011 and a pair of restricting portions 2012 bent downwardly from opposite lateral sides of the base portion 2011. Each restricting portion 2012 defines a plurality of recesses 2013 at its bottom edge, a plurality of protrusions 206 each formed between the adjacent two recesses 2013, and a plurality of hollow press-fit legs 2014 extending downwardly from corresponding protrusions 206. Besides, the base portion 2011 includes a plurality of cutouts 2015 at the rear side thereby forming a plurality of tabs 2016 each of which is formed between the adjacent two cutouts 2015. The base portion 2011 further includes a plurality of first slits 2017 opposite to the tabs 2016.

Each restricting portion 2012 includes a plurality of bent protrusions 2018 at the rear side thereof. Each restricting portion 2012 includes a rear cutout 20121 for receiving the first block 16. Besides, the bottom edges of the restricting portions 2012 is inserted into the positioning slits 171 of the second blocks 17. As a result, the first cage 201 can be stably fixed to the insulative housing 10.

Each restricting portion 2012 includes a plurality of openings 2019 and two restricting pieces 20191 protruding inwardly towards the first cage 201. One of the restricting pieces 20191 is adapted for abutting against a front side of the receiving portion 12, and the other of the restricting pieces 20191 is adapted for abutting against a top side of the fixing slot 18. As a result, the first cage 201 can be stably fixed to the insulative housing 10.

The second cage 202 includes a shielding plate 2021 and a plurality of locking arms 2022 bent upwardly from opposite lateral sides of the shielding plate 2021. Each locking arm 2022 includes a plurality of slits 2023 and a plurality of connecting portions 2024 each of which is located between the adjacent two slits 2023. Each shielding plate 2021 includes a plurality of engaging portions 2025 each of which extends towards corresponding slit 2023. When the press-fit legs 2014 extend through the slits 2023, the locking arms 2022 are located outside of corresponding restricting portions 2012 so that the corresponding restricting portions 2012 are limited along an inside-to-outside direction, while the engaging portions 2025 are located inside of the protrusions 206 so that the corresponding restricting portions 2012 are limited along an outside-to-inside direction. As a result, the integral strength of the first cage 201 and the second cage 202 is improved and signal transmission can be protected because of the excellent shielding effect. Besides, the shielding plate 2021 includes a plurality of second slits 2026.

Referring to FIGS. 1, 2 and 10, the third cage 203 includes a first shielding portion 2031 covering the base portion 2011 of the first cage 201, a second shielding portion 2032 bent downwardly from the first shielding portion 2031 to cover the insulative housing 10, and a pair of third shielding portions 2033 bent forwardly from lateral edges of the second shielding portion 2032. The pair of third shielding portions 2033 are lockable to the pair of restricting portions 2012 of the first cage 201. The second shielding portion 2032 is perpendicular to the first shielding portion 2031 and the third shielding portions 2033. The second shielding portion 2032 includes a plurality of press-fit legs 2034 for being mounted to the circuit board.

A joint of the first shielding portion 2031 and the second shielding portion 2032 defines a plurality of through holes 2035 through which the tabs 2016 are inserted. Joints of the third shielding portions 2033 and the second shielding portion 2032 define a plurality of through holes 2036 to lock with the bent protrusions 2018. According to the illustrated embodiment of the present invention, the through holes 2035, 2036 are of rectangular configurations, the first cage 201 and the third cage 203 can be well assembled with the tabs 2016 and the bent protrusions 2018 respectively locking in the through holes 2035, 2036. Simultaneously, the shielding effect of the first cage 201 and the third cage 203 can be ensured.

The metallic shell 200 includes a plurality of separating plates 204 between the first cage 201 and the second cage 202. Each separating plate 204 includes a plurality of L-shaped locking tabs 2041 fixed to the base portion 2011 of the first cage 201 and a plurality of press-fit portions 2042 extending downwardly through the shielding plate 2021 of the second cage 202. The locking tabs 2041 extend through the first slits 2017, and the press-fit portions 2042 extend through the second slits 2026 for supporting the first cage 201 and the second cage 202. Besides, each separating plate 204 further includes a pair of upward and downward protuberances 2043 on top and bottom side thereof.

The metallic shell 200 includes a plurality of grounding pieces 205 surrounding around the first cage 201 and the second cage 202. At least one of the grounding pieces 205 defines a through opening 2051 to receive the upward protuberance 2043. According to the illustrated embodiment of the present invention, the grounding pieces 205 are soldered to the first cage 201 and the second cage 202 via spot welding. The third cage 203 is fixed to the first cage 201 via spot welding. The second cage 202 is fixed to the first cage 201 via spot welding as well.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An electrical connector assembly comprising:
a plurality of stacked connectors comprising:
an insulative housing comprising a mating portion and a receiving portion extending rearwardly from the mating portion; and
a plurality of contact groups received in the insulative housing; and
a metallic shell enclosing the stacked connectors; wherein
the contact groups comprise a first contact group, a second contact group, a third contact group and a fourth contact group, each of the contact groups comprises a plurality of contacts, and the contacts of the first, second, third and fourth contact groups are separable and are arranged in turn along a top-to-bottom direction and a rear-to-front direction.

2. The electrical connector assembly as claimed in claim 1, wherein each of the first, second, third and fourth contact groups comprises at least one spacer over-molding the contacts.

3. The electrical connector assembly as claimed in claim 2, wherein each contact comprises a contacting section, an extending section extending rearwardly from the contacting section, a bent section bent downwardly from the extending section and a press-fit leg extending from the bent section.

4. The electrical connector assembly as claimed in claim 3, wherein the press-fit legs are of V-shaped or Z-shaped configurations.

5. The electrical connector assembly as claimed in claim 4, wherein the press-fit legs of adjacent contacts of the same contact group are bent along opposite directions.

6. The electrical connector assembly as claimed in claim 4, wherein the press-fit legs of the same contact group are arranged in two rows.

7. The electrical connector assembly as claimed in claim 3, wherein each of the first, second, third and fourth contact groups comprises a first spacer over-molding the extending sections and a second spacer over-molding the bent sections and/or part of the press-fit legs.

8. The electrical connector assembly as claimed in claim 7, wherein the first spacer is perpendicular to the second spacer.

9. The electrical connector assembly as claimed in claim 3, wherein the mating portion defines a mating slot and a plurality of upper and lower passageways in communication with the mating slot, the upper and lower passageways extending rearwardly through the receiving portion, the contacting sections of the adjacent contact groups extending into the same mating slot being arranged in a face-to-face manner.

10. The electrical connector assembly as claimed in claim 7, wherein the receiving portion defines a plurality of guiding slots to receive the first spacers of the contact groups, each first spacer comprising a pair of opposite inclined surfaces for easily guiding insertion of the first spacers.

11. The electrical connector assembly as claimed in claim 7, wherein the receiving portion defines a plurality of locking slots to fix the second spacers of the contact groups, each second spacer comprising a pair of locking blocks secured in the locking slots.

12. The electrical connector assembly as claimed in claim 11, wherein each second spacer comprises a restricting block connected above corresponding locking block, and the receiving portion defines a plurality of restricting slots above the locking slots to receive the restricting blocks.

13. An electrical connector assembly comprising:
a plurality of stacked connectors comprising:
an insulative housing comprising a mating portion and a receiving portion extending rearwardly from the mating portion; and
a plurality of contact groups received in the insulative housing; and
a metallic shell enclosing the stacked connectors; wherein
the contact groups comprise a first contact group, a second contact group, a third contact group and a fourth contact group, each of the contact groups comprises a plurality of contacts and at least one spacer over-molding the contacts, each contact comprises a contacting section, an extending section extending rearwardly from the contacting section, a bent section bent downwardly from the extending section and a press-fit leg extending from the bent section; and wherein
the contacting sections of the first, second, third and fourth contact groups are arranged in turn along a top-to-bottom direction in four stories, and the press-fit legs of the first, second, third and fourth contact groups are arranged in turn a rear-to-front direction in eight rows.

14. The electrical connector assembly as claimed in claim 13, wherein the press-fit legs are of V-shaped or Z-shaped configurations.

15. The electrical connector assembly as claimed in claim 14, wherein the press-fit legs of adjacent contacts of the same contact group are bent along opposite directions.

16. The electrical connector assembly as claimed in claim 14, wherein the press-fit legs of the same contact group are arranged in two rows.

17. The electrical connector assembly as claimed in claim 13, wherein each of the first, second, third and fourth contact groups comprises a first spacer over-molding the extending sections and a second spacer over-molding the bent sections and/or part of the press-fit legs.

18. The electrical connector assembly as claimed in claim 17, wherein the receiving portion defines a plurality of guiding slots to receive the first spacers of the contact groups, each first spacer comprising a pair of opposite inclined surfaces for easily guiding insertion of the first spacers.

19. The electrical connector assembly as claimed in claim 17, wherein the receiving portion defines a plurality of locking slots to fix the second spacers of the contact groups, each second spacer comprising a pair of locking blocks secured in the locking slots.

20. The electrical connector assembly as claimed in claim 19, wherein each second spacer comprises a restricting block connected above corresponding locking block, and the receiving portion defines a plurality of restricting slots above the locking slots to receive the restricting blocks.
